(19) United States
(12) Patent Application Publication
(10) Pub. No.: US 2022/0253944 A1
(43) Pub. Date: Aug. 11, 2022

(54) SYSTEM TO GENERATE A BINDABLE INSURANCE QUOTE AND RELATED METHODS

(71) Applicant: SIMPLYIOA, LLC, Longwood, FL (US)

(72) Inventor: Brian McDowell, Longwood, FL (US)

(21) Appl. No.: 17/676,459

(22) Filed: Feb. 21, 2022

Related U.S. Application Data
(63) Continuation of application No. 17/036,835, filed on Sep. 29, 2020.
(60) Provisional application No. 62/879,647, filed on Jul. 29, 2019.

(51) Int. Cl. G06Q 40/08; G06F 16/953; G06F 9/54; G06Q 30/00

(52) U.S. Cl. CPC G06Q 40/08; G06Q 30/01; G06F 9/541; G06F 16/953

(57) ABSTRACT

A system to generate a bindable insurance quote includes an end-to-end fully automated platform to quote and purchase insurance all in one transaction. The system includes an enterprise service bus configured to manage communications between mutually interacting software applications of the system. The system also includes an application programming interface (API) in communication with the enterprise, service bus, a model view controller (MVC) in communication with the APT, and a data enrichment module in communication with the API. The system may include a plurality of insurance frontend graphical user interfaces (GUIs) that are embedded into respective partner HTML pages as an inline frame element or a plurality of partner branded insurance frontend GUIs. The system may include a widget embedded into a respective partner HTML to enter customer data The system may include a plurality of partner insurance frontend GUIs that are configured to collect the customer data.

### RELATED APPLICATIONS

The present invention is a continuation-in-part of U.S. patent application Ser. No. 17/036,835 filed Sep. 29, 2020, which claims priority to Provisional Patent Application Ser. No. 62/879,647 filed Jul. 29, 2019, the entire contents of these applications incorporated herein by reference.

### TECHNICAL FIELD

The present invention relates to the field of insurance, and, more particularly, to a system to generate a bindable insurance quote and related methods.

### BACKGROUND

The process for shopping for home and auto insurance has not changed much over the years, If the consumer were to request an insurance quote from the top five home and auto carriers in the United. States it may take an hour or more. Further, after all that time spent the consumer may not find a better price or correctly enter the proper rating information to ensure a proper price they should be receiving.

Alternatively, the consumer could use an online quoting platform but again it is a time consuming process. In addition, the personal identifying information and contact information is shared with others before a bindable price quote is even presented to the customer. This leads to unsolicited phone calls and emails from multiple insurance companies contacting the customer. Moreover, the renewal and midterm adjustment of insurance policies is burdensome and time consuming to both the customer and the insurance agents.

Accordingly, there is a need to develop an improved system and method that allows consumers to shop for insurance and receive bindable quotes for insurance policies.

### SUMMARY

A system to generate a bindable insurance quote from insurance carriers that can be used for any product lines is disclosed. The system generates a quote that a customer can purchase in real time without providing additional information. The system is an end-to-end fully automated platform to quote and purchase insurance and is accomplished all in one transaction. This is in contrast to existing insurance quoting systems where the price initially displayed to the customer is not accurate and not truly available to the customer. Instead, the low price initially displayed to the customer is nothing more than a sales technique for the customer to enter more personal information before a bindable price quote for a policy is presented that the customer can actually purchase. The current system overcomes the deception of the existing insurance websites and truly can provide bindable insurance prices for policies that the customer can purchase without providing substantial more personal information until a bindable quote price is presented.

The system includes an enterprise service bus configured to manage communications between mutually interacting software applications of the system. The system also includes an application programming interface (API) in communication with the enterprise service bus, a model view controller (MVC) in communication with the API, and a data enrichment module in communication with the API, where the data enrichment module comprises third party web services used to retrieve customer and property data to prefill an insurance application with policy information. In addition, the system includes an underwriting module in communication with the enterprise service bus, where the underwriting module comprises a service application configured to communicate customer and property data between a plurality of insurance carriers. The system includes an external rating engine and a handshaking algorithm, where the handshaking algorithm is interposed between the external rating engine and the underwriting module and configured to manage rate calls with the external rating engine for the bindable insurance quote.

The system may include a plurality of insurance frontend graphical user interfaces (GUIs) that are embedded into respective partner HTML pages as an inline frame element.

In another aspect, the system may include a plurality of partner branded insurance frontend graphical user interfaces (GUIs) of the MVC that are configured to enter the customer and property data.

In yet another aspect, the system may include a widget embedded into a respective partner HTML page and be configured to launch an inline frame element on the respective partner HTML page or to open a respective partner branded insurance frontend graphical user interface (GUI) when the widget is toggled in order to enter the customer and property data.

In another aspect, the system may include a plurality of partner insurance frontend graphical user interfaces (GUIs) that are configured to collect the customer and property data and transmit the customer and property data to the enterprise server bus via a partner API in order to receive the bindable insurance quote.

The external rating engine comprises web services configured to communicate to the plurality of insurance carriers to send customer and enrichment information in exchange for the bindable insurance quote.

The system may also include a marketing module in communication with the service bus and a customer relationship (CRM) module, where the CRM module comprises a system configured to manage new leads. The system includes a portfolio management module in communication with the service bus, where the portfolio management module comprises a service application configured to communicate policy and customer information to agency management services (AMS). The AMS comprises a management system that is configured to manage customers and their respective insurance policies.

The system may include a payment API in communication with in carrier direct services, the MVC, and the enterprise service bus, where the insurance direct services comprise web services and third party applications for insurance carrier payment processing.

Another aspect is directed to a method to generate a bindable insurance quote from insurance carriers for any product lines. A customer can purchase a policy in real time using the bindable insurance quote without providing additional information. The method includes using an enterprise service bus configured to manage communications between mutually interacting software applications. The method includes receiving customer and property data that was entered using a graphical user interface (GUI) of a model view controller (MVC) that is in communication with an application programming interface (API). The method also includes transmitting the customer and property data by the API to a data enrichment module comprising third party wen services used to retrieve additional customer and property data to prefill an insurance application with policy information, where enriched customer and property data is returned from the data enrichment module. In addition, the method includes transmitting the enriched customer and property data to an underwriting module, where the underwriting module comprises a service application configured to communicate the enriched customer and property data between a plurality of insurance carriers. The method includes transmitting the enriched customer data from the underwriting module to an external rating engine via a handshaking algorithm, where the handshaking algorithm is interposed between the external rating engine and the underwriting module and is configured to manage rate calls with external rating engine for the bindable insurance quote.

The method may also include embedding a plurality of insurance frontend graphical user interfaces (GUIs) into a respective partner HTML page as an inline frame element in order to enter the customer and property data, and each of the plurality of insurance frontend GUIs are in communication with the MVC.

In another aspect, the method may include providing a plurality of partner branded insurance frontend graphical user interfaces (GUIs) that are configured to enter the customer and property data.

In yet another aspect, the method may include embedding a widget into a respective partner HTML page and launching an inline frame element on the respective partner HTML page or opening a respective partner branded insurance frontend GUI when the widget is toggled in order to enter the customer and property data.

In another aspect, the method may include collecting the customer and property data using a plurality of partner insurance frontend graphical user interfaces (GUIs), and transmitting the customer and property data to the enterprise server bus via a partner API to receive the bindable insurance quote from the plurality of insurance carriers.

The method may also include display the bindable insurance quote for the insurance policy using the GUI, receiving a selection using the GUI of a selected insurance policy from the bindable insurance quote to purchase, transmitting the selected insurance policy to a lead management system and stored, receiving payment information from the customer to finalize the purchasing and binding of the selected insurance policy, and transmitting a confirmation to the customer of their new insurance policy once payment is processed.

Yet another aspect directed to non-transitory computer readable medium for generating a bindable insurance quote using an enterprise service bus configured to manage communications between mutually interacting software applications, and with the non-transitory computer readable medium having a plurality of computer executable instructions for causing a system to perform steps as described above.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a block diagram of a system to generate a bindable insurance quote in accordance with the present disclosure;

FIG. 2 is a block diagram of an insurance frontend graphical user interface (GUI) embedded into a partner HTML page as an inline frame element

FIG. 3 is a block diagram of a plurality of partner branded insurance frontend GUIs configured to enter the customer and property data.

FIG. 4 is a block diagram of a widget embedded into a respective partner HTML page.

FIG. 5 is a block diagram of a plurality of partner insurance frontend GUIs.

FIG. 6 is a block diagram of an application programming interface (API) of the system of FIG. 1 to obtain an insurance quote;

FIG. 7 is a block diagram of an API of the system of FIG. 1 for payment to bind the insurance quote;

FIG. 8 is a general flow diagram of a method of generating the bindable insurance quote using the system of FIG. 1 or FIG. 4;

FIG. 9 is a flow diagram of a method of generating a bindable automobile insurance quote;

FIG. 10 is a flow diagram of a method of generating a bindable home insurance quote;

FIG. 11 is a general block diagram of high level architecture of the system of FIG. 1;

FIG. 12 is a flow diagram of a method for renewing an insurance policy using the system of FIG. 1;

FIG. 13 is a flow diagram of a method of making a mid-term change of address to the policy using the system of FIG. 1;

FIG. 14 is a flow diagram of a method of making a mid-term change of coverage to the insurance policy using the system of FIG. 1;

FIG. 15 is a flow diagram of a method of making a mid-term addition or removal of a vehicle from the insurance policy using the system of FIG. 1; and

FIG. 16 is a flow diagram of a method of making a mid-term addition or removal of a driver from the insurance policy using the system of FIG. 1.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Current online websites that offer insurance policies from various insurance carriers do not use robust data enrichment and quoting rules to generate price quotes for insurance policies. In addition, existing insurance websites do not allow the customer to immediately purchase the policy with the quoted price without first providing substantial more additional personal information.

Accordingly, often times the insurance price quoted and displayed to the customer is not accurate and not truly available to the customer. Instead, a low price initially displayed to the customer is nothing more than a sales technique for the customer to enter more personal information before a price quote for a policy is presented that the customer can actually purchase. The current system overcomes the deception of the existing insurance websites and truly can provide bindable insurance prices for policies that the customer can purchase without providing substantial more personal information or vehicle information until a bindable quote price is presented.

The system may run on the cloud and use a virtual machine (“VM”) or a cluster of VMs to scale up or down depending on the traffic. Load balancing solutions may be used to optimize the number and size of required VMS in order to optimize performance for the best possible customer experience. In addition, specification of other hardware used for the enhanced functionality of the system may include a plurality of servers. Storage for the system may include flash based storage, for example, PCI nVMe SSDs set up in a redundant array and have multiple NIC to provide the fastest possible data transfer.

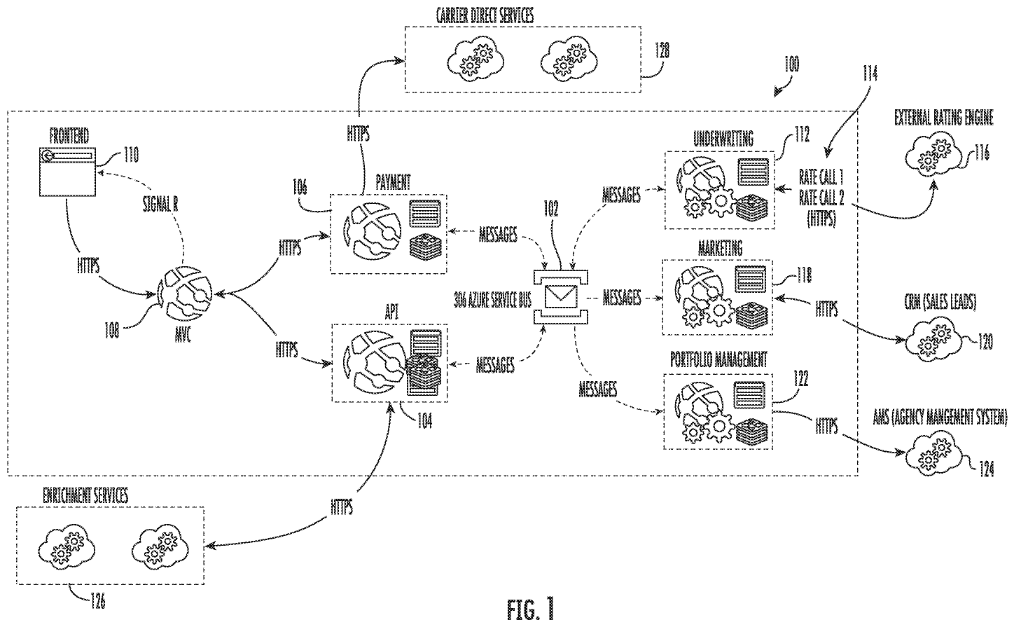

Referring now to FIG. 1, a system to generate a bindable insurance quote is disclosed and generally designated 100. The system includes an enterprise service bus 102 that is configured to manage communications between mutually interacting software applications of the system 100. For example, the application programming interface (API) 104 is in communication with the service bus 102. The API 104 is in communication with the model view controller (MVC) 108 and the insurance frontend 110 over a communication system, e.g., the Internet.

A payment API 106 is also in communication with the MVC 108 and the frontend 110. The payment API 106 is also in communication with insurance direct services 128, which may include, web services and third party applications for insurance carrier payment processing.

The APT 104 is in communication with a data enrichment module 126 that comprises third party web services used to retrieve customer and property data to prefill and default policy information. The data enrichment module 126 reduces the need for the customer to answer most of the insurance application questions that are typically required.

The system 100 may also include using model based data imputation algorithms to fill in all the missing data required for an insurance application. In addition, rule based logic may be added to perform sanity checks and present the most accurate information. The system 100 assembles the vehicle or property information and retrieves information about the customer that may include demographic, economic, household, prior convictions, and other relevant information.

In addition, the system 100 also reduces the need for the customer to select appropriate coverage levels for their financial situation. The data enrichment module 126 is configured to use various algorithms to generate output to indicate negative activity such as whether the customer is in significant debt, has passed fraudulent checks, and other similar types of negative events, for example.

The system 100 eliminates many of the typical insurance questions the customer must answer to obtain a price quote, for a policy. The system 100 also provides an easy and convenient way to acquire an insurance policy and comparative rates of insurance for the customer while allowing the customer an option to purchase an insurance policy at same price as presented in the price quote.

The system 100 may include a layer of rule based logic to exclude unwanted customers and divert them to other channels in order to obtain more detail. In addition, the system 100 may include sanity checks in order to prevent including poor quality customers. Moreover, the system 100 configured to use logic to overwrite data with the most current and most reliable information.

The service bus 102 is in communication with an underwriting module 112, a marketing module 118 and a portfolio management module 122. The underwriting module 112 comprises a service application which communicates the customer data between insurance carriers in order to retrieve bindable insurance quotes using a handshaking algorithm 114 between an external rating engine 116 for making rate calls (e.g., rate call 1 and rate call 2). The external rating engine 116 comprises web services which communicate to the insurance carriers to send customer and enrichment information in exchange for a bindable quote for insurance. The system 100 may be configured to select price quotes that would be the best match for the customer, which maximizes the probability of conversion, maximizes customer satisfaction, and minimizes acquisition costs.

These features of the system 100 overcome ma of the shortcomings that currently exist in online insurance purchasing options by providing a system 100 that is configured to generate quotes based on actionable insights derived from sets of data provided by the customer. The above sequencing of operations by the system 100 may shorten the insurance application procedure to just three minutes or less and will ensure the customer 146 has selected the appropriate amount of insurance. The data capture operation is more efficient because customers have to enter minimal information in order to receive a price quote for insurance from the insurance carriers that are matched with the coverage needs of the customer.

In a particular aspect, the handshaking algorithm 114 used for rate calls may be as follows for an auto policy, for example:

```
Quote Rate Call Request
private static applied.RateCalllAutoRatingRequest BuildRequest(
  PersonalAutoApplication application,
  PersonalAutoEnrichment enrichment,
  PersonalAutoQuotePackageDefaults defaults,
  int? primaryDriverindex,
  int? coApplicantDriverIndex,
  AppSettings appSettings,
  AppSecrets appSecrets,
  IEnumerable<applied.CarrierRateRequest> carrierRequests)
  {
  var insuredDriver = application.Drivers,ElementAt(primaryDriverIndex ?? 0);
  var rep Authorization = new applied. ReportAuthorizationinformation
  {
    CreditDisclosure = true,
    CreditDisclosureDate = DateTime.Now
  };
  var currentPolicy = new applied.CurrentPolicylnformation
  {
    InsuranceStatus = CoveredInsuranceStatus,
    PriorCarrier = application,CurrentOrRecentCoverage.CarrierName,
    Time WithCarrier = MapTimeWithCarrier(application.CurrentOrRecentCoverage),
    PriorliabtyLimits =
MapCurrentPolicyLiabtylimits(application,CurrentOrRecentCoverage),
  CurrentPolleyExpirationDate =
application.CurrentOrRecentCoverage.PokyExpirationDate,
  YearContinuousCoverage =
application,CurrentOrRecentCoverage.ContinuousCoverage,NumberOfYears,
  MonthsContinuousCoverage =
application.CurrentOrRecentCoverage.ContinuousCoverage.Number0fMonths
  };
  var desiredCoverage = new AutoDesiredCoverageinformation
  {
    Bodilyinjury = defaults,Bodilylnjury?ToLimitString(),
    MedicalPayments = defaults.MethcalPayments?JoStringa.
    PioAppliesTo = defaults,PipAppliesTo,
    PipDeductible = defaults.PpDeductble,
    PipType = defaults,PipType,
    PipWageloss = defaults.PipWageLoss,
    UninsuredMotorist = defaults.UninsuredMotorist?.ToLimitString(),
    UninsuredMotoristStacked = false,
    PolicyTelematics = appiication.HasTelematics(),
    PropertyDamage = defaultsPropertyDamage?JoStringo
  };
  var contactinformation = new applied.ContactInformation
  {
    CustornerPhoneNumber =
application.Applicant,PrimaryPhoneNumber.CleanPhoneNumber(),
    CustomerEmail = string.lsNullOrWhiteSpace(application.Applicant.Email) ? null:
application.ApplicantEmail
  };
  var request = new applied.RateCall1AutoRatingRequest
  {
  Customerid = null,
  IsDemo = appSettings.AppliedOneClickTestMode,
  Risk = new applied.RateCall1AutoRisk
  {
    Addresses = MapAddresses(application, enrichment),
    Applicantindex = primaryDriverindex,
    CarrierQuestions = MapCarrierQuestions(application),
    CoApplicantindex = coApplicantDriverIndex,
    ContactInfor ation = contactInformation,
    ContractEffectiveDate = (application.DesiredPolicyEffectiveDate <
DateTime,Today) ? DateTime.Today : application.DesiredPolicyEffectiveDate,
      CurrentPolicy = currentPolicy,
      DesiredCoverage = desiredCoverage,
      Drivers = MapDrivers(application),
      Homelnsurance = NotApplicableString,
      Incidents = null, //intentional
      Miscellaneous = null, //intentional
      PolicyTerm = PolicyTerm,
      RatingCounty = NotApplicableString,
      RatingState = application,Applicant.InsuredAddress,StateType?.ToStateCode(),
      ReportAuthorization = reportAuthorization,
      ResidenceStatus = MapResidenceStatus(insuredDriver.PrimaryResidence),
      Vehicles = MapVehicles(application, enrichment, defaults)
    },
    Carriers = carrierRequests?.ToList()
  };
    return quest;
  }
```

The marketing module 118 is in communication with a customer relationship management (CRM) module 120. The CRM module 120 comprises a system to manage new leads in order to market and sell to customers who went through (partially or completely) through the insurance application process.

The portfolio management module 122 comprises a service application which communicates policy and customer information between the insurance application and agency management services (AMS) 124. The AMS 124 comprises a management system configured to manage customers and insurance policies.

The system 100 described above can be implemented and distributed in different industries to partners. For example, the system may be used with personal lines insurance agencies as a partner. The system 100 streamlines the quote process allowing agents to sell more policies, quicker. Agencies can also benefit from the economies of scale that the system 100 provides by giving access to insurance carriers that may otherwise be out of reach and more competitive commissions.

Auto dealerships are another example of a potential partner where the system 100 may be implemented. Given the current landscape within the auto industry, dealerships are looking for additional streams of revenue. Accordingly, with auto insurance being a key component to auto sales, the system can be implemented for dealers to offer and obtain bindable insurance quotes for their customers.

Mortgage brokers are yet another example, of where the system 100 may be implemented and be a partner. The home purchasing and refinancing process can be complicated for borrowers and home insurance is an integral part in ensuring the transaction closes seamlessly and on time. Thus, the mortgage industry is a good fit for the system 100.

In addition, insurance carriers may be a partner to collect an abundance of data about their potential and current clients. They are able to do market analysis on consumer behavior and competitor analysis. There is a need for more in depth detail to fully understand where they fit in the marketplace. The system 100 can provide this by compiling data from the multiple sources that each quote generates.

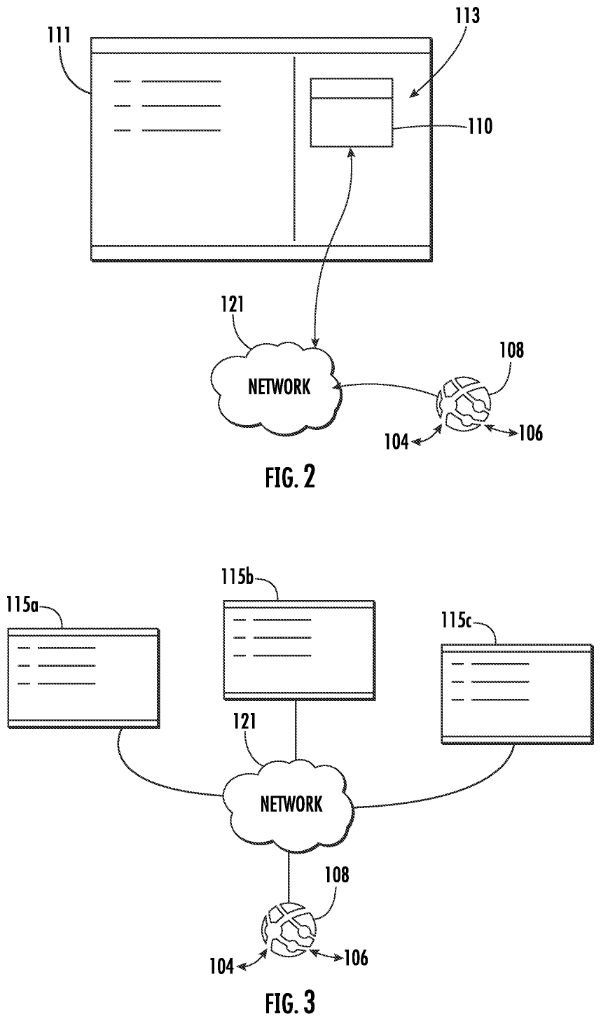

Referring now to FIG. 2, the insurance frontend GUI 110 of the MVC 108 is illustrated embedded into a respective partner HTML page 111a as an inline frame element 113. As explained above, the partner HTML page 111a may be an insurance agency, a car dealership, or a mortgage broker, for example, and for any product lines. The inline frame element 113 allows the customer to begin the process to obtain a bindable insurance quote. The inline frame element 113 is easily embedded on the partner site with no integrations required.

Referring now to FIG. 3, a block diagram of a plurality of partner branded insurance frontend GUIs 115a, 115b, 115c are illustrated and are configured to enter the customer and property data (collectively, the “data”). In this particular aspect, a copy of the frontend 110 is created, branded for each partner, but the system 100 operates and is configured the same otherwise The partner branded insurance frontend GUIs 115a, 115b, 115c collect the data and transmit to the MVC 108 via network 108. The network may be in an intranet or Internet, and wired or wireless, for example.

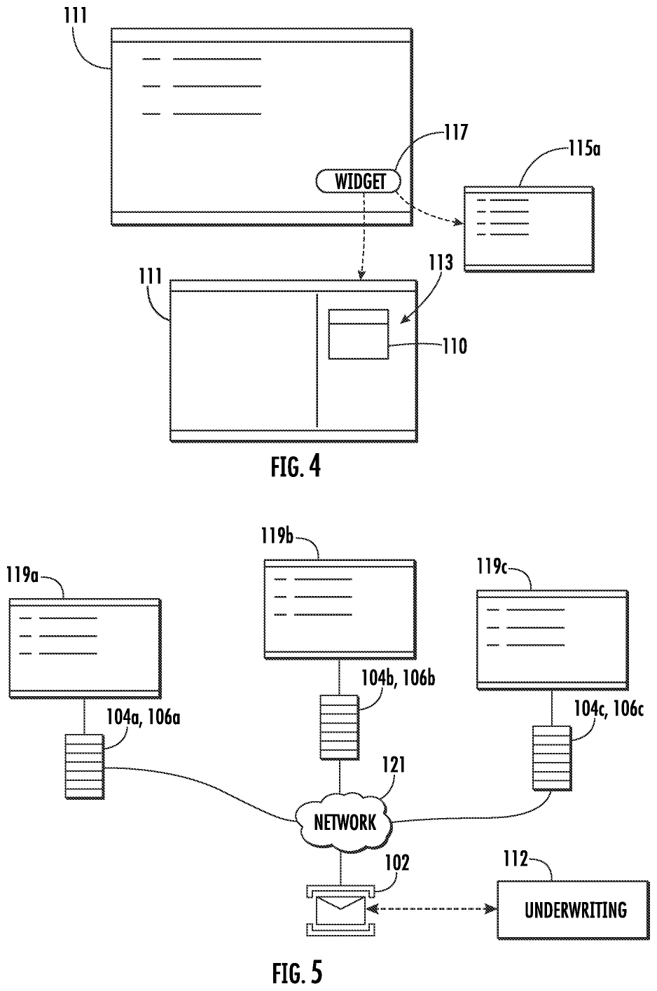

Referring now to FIG. 4, a block diagram of a widget 117 embedded into a respective partner HTML page. The widget 117 is configured to launch an inline frame element 113 on the respective partner HTML page 111 as discussed above, or to open a respective partner branded insurance frontend GUI 115a of the MVC when the widget 117 is toggled in order to enter the data. The widget 117 comprises a small piece of code embedded into the HTML page 111 on their website to allow their consumers to start the journey on their site and then bridge over to either the inline frame element 113 or the partner branded GUI 115a.

Referring now to FIG. 5, a block diagram plurality of partner insurance frontend GUIs is illustrated. In contrast to the implementation of a copy of the frontend 110 being branding as discussed with respect to FIG. 3 above, the plurality of partner insurance frontend GUIs 119a, 119b, 119c are each configured to collect the data and transmit over the network 121 the data to the enterprise server bus 102 via a partner API 104a, 106a; 104b, 106b; 104c, 106c in order to receive the bindable insurance quote. This aspect requires more integration effort on the part of the partner but gives the most integrated solution. The partner recreates the customer journey on their website utilizing its own API to collect and convey data directly to the enterprise server bus 102 of the system 100 and receiving a bindable quote in response.

If partners do not want to directly offer the ability for their customers to obtain a bindable insurance quote as described above with respect to FIGS. 2-5, their customers can be referred to the system 100 as a customer lead. For example, the partner can capture the customer information on their website page 111 and transmit the data using an integrated API. In another aspect, a partner branded insurance lead form can be hosted by the system 100 to collect customer information. Also, a widget can be embedded into the partner's website page 111 to allow their customer to enter data and submit to the system 100.

The data that the system 100 captures during the course of normal business can be utilized by those in the insurance industry to understand the market, consumer behavior, carrier behavior and beyond. Data sources available for use in analysis include the data generated by the customer to obtain a bindable quote using the system 100, and data generated by sales agents quoting their customers through the system, for example. In addition, data may be gleaned from marketing efforts and analysis and also through customer data captured via lead management of the sales process. Data may also be captured during the value exchange with partner carriers to obtain the bindable quotes.

The type of information that can be gained from an analysis of this data can include where a competitor falls against their peers (e.g., price competitiveness, coverage levels, risk level, geographic coverage), and consumer behavior as it relates to purchasing insurance.

In addition, this data can provide insights of carriers within the same insurance space to understand where the market, and opportunities are. A customer's own portfolio of customer and agent data that has been submitted through the system 100 can be analyzed, along with insurance premiums collected from policies sold versus what carriers are paying in claims. The geographic locations down to the zip code level and consumer behavior based upon demographic data collected through the system 100 can be analyzed.

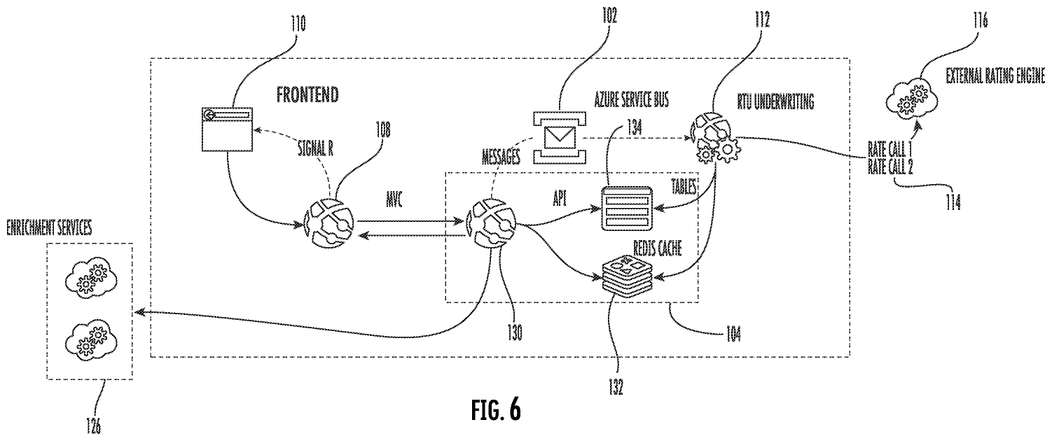

Referring now to FIG. 6, a block diagram of the API 104 of the system of FIG. 1 is shown. In particular the API 104 includes an API 130 that is configured to communicate and process data between the front end 110 and the MVC application 108 and back end systems. The frontend 110 comprises a web based user interface to begin the application process. The API 130 is in communication with cache 132 (e.g., Redis cache) to store data which can be stored and refreshed from tables 134 to store application data at intervals to improve data performance.

The details of the insurance policies that are available with bindable price quotes are displayed, to the customer on the GUI. The customer can also view the details of the policy document he or she is going to purchase. The premium amount and any additional coverage of the policy are provided. After the preview of the comprehensive policy, the customer is provided an opportunity to preview information they have entered to confirm before appending the E- signature on it. A preview of the comprehensive insurance coverage, its benefits and details of the owner and drivers of a vehicle are provided. The customer can view all details that will be put on the insurance policy such as driver details, vehicle details, coverage details, for example, and the customer verifies same.

When the customer approves all previous details they are sent to payment page. The system may allow different payment options and varies for different insurance companies as to the method of acceptable payments.

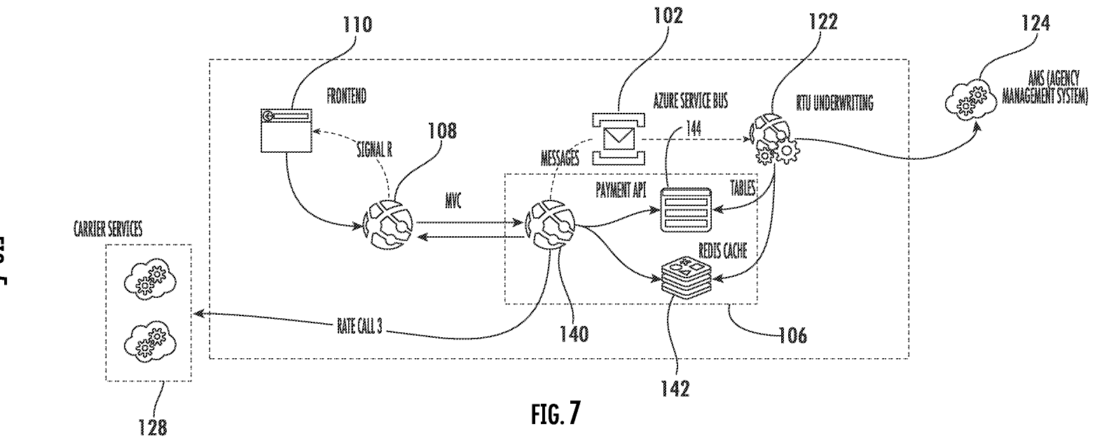

A block diagram of the payment API 106 is shown in FIG. 7. Similar to the API 104, the payment API 106 includes an API 140 that is configured as an interface between the frontend 110 and the MVC application 108. The API 140 is in communication with cache 142 to store data which can be stored and refreshed from tables 144 to store application data at intervals to improve data performance.

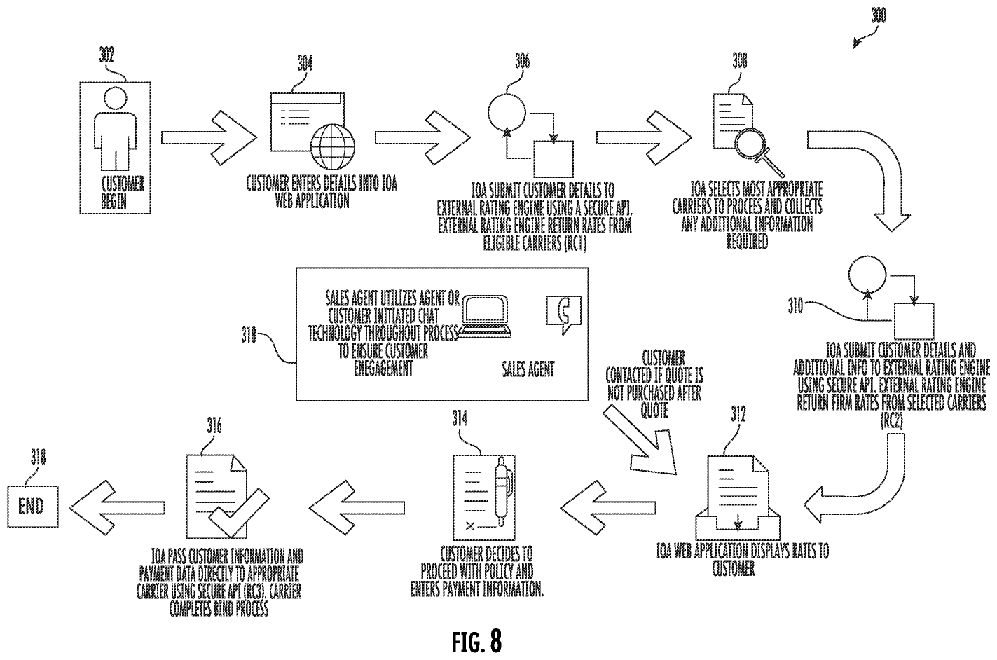

Referring now to FIG. 8, a general flow diagram is shown illustrating a method 300 of generating the bindable insurance quote for auto insurance using the insurance system of FIG. 1. The method 300 begins at 302, and the customer enters details into the web application, at 304. The customer details are submitted, at 306, to the external rating engine using a secure API. The external rating engine returns rates from the eligible carriers via handshaking algorithm (e.g., rate call 1), at 306. The most appropriate carriers of the eligible carriers are selected to proceed, and additional information is collected, at 308, from the customer.

Moving to 310, customer details and additional customer information is submitted to the external rating engine again using the secure API. The external rating engine returns bindable rates from the selected carriers via the handshaking algorithm (e.g., rate call 2). The web application displays the bindable rates to the customer, at 312, so that the customer can decide and select a policy and enter payment information, at 314. In addition, a sales agent may initiate chat technology, at 318, in order to initiate communicate with the customer or if the customer does not purchase the policy after the bindable rates are displayed at 312. After the customer selects a policy and pays, at 314, the customer information and payment data is forwarded to the selected insurance carrier using a secure API (e.g., rate call 3), at 316, or payment can occur through embedding modules provided by the carrier, and the carrier completes the binding process and the method ends, at 318.

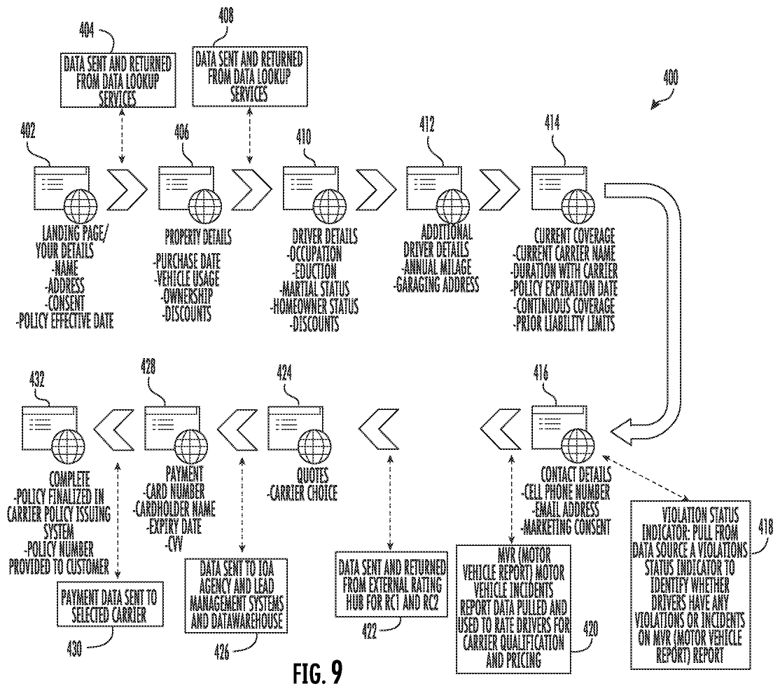

Referring now to FIG. 9, a flow diagram of a method of generating a bindable automobile insurance quote 400 is shown. The method 400 begins, at 402, where basic customer data is entered including name, address, consent, and policy effective date, for example. The customer data is sent, at 404, and vehicle data is returned from data lookup services. The vehicle data is presented to the customer, at 406, and the customer can add or edit the vehicle data. This includes vehicle purchase date, vehicle usage, ownership, and discounts, for example. The vehicle data is sent, at 408, and driver data is returned from data lookup services. The driver data is presented to the customer, at 410, and the customer can add or edit the driver data. Moving to 412, drivers are assigned to specific vehicles and annual mileage, and the primary vehicle location is identified. The customer enters information regarding their current insurance policy and coverage, at 414. This may include duration with the carrier, policy expiration date, and prior liability limits, for example. A violation status indicator is then pulled from a data source, at 418, to determine whether the drivers has any violations or incidents on a motor vehicle report (MVR).

The customer then enters their contact details, at 420, which may include a cell phone number, email address, and marketing consent, for example, MVR data is then pulled, at 420, to identify any specific violations or incidents and is used to rate drivers for carrier qualification and pricing, Data is sent, at 422, and returned from the external rating engine for rate call 1 and rate call 2.

The customer, at 424, is presented with bindable insurance quotes that are displayed on the GUI and can be purchased directly. The customer is presented with details regarding the coverage levels of the proposed insurance policy, and allowing the customer to add or edit coverage levels. The customer can also view comparative quotes from multiple insurance carriers as availability allows, The pertinent data may be sent to lead management systems and stored, at 426, before or after the customer selected the policy.

The customer then enters payment information, at 428, to finalize the purchasing and binding of the selected insurance policy, The payment information includes credit card number, cardholder name, and expiration date, for example, and provided to the carrier, at 430. Moving to 432, confirmation is provided to the customer that their new insurance policy has been purchased and a policy number provided by the carrier to the customer,

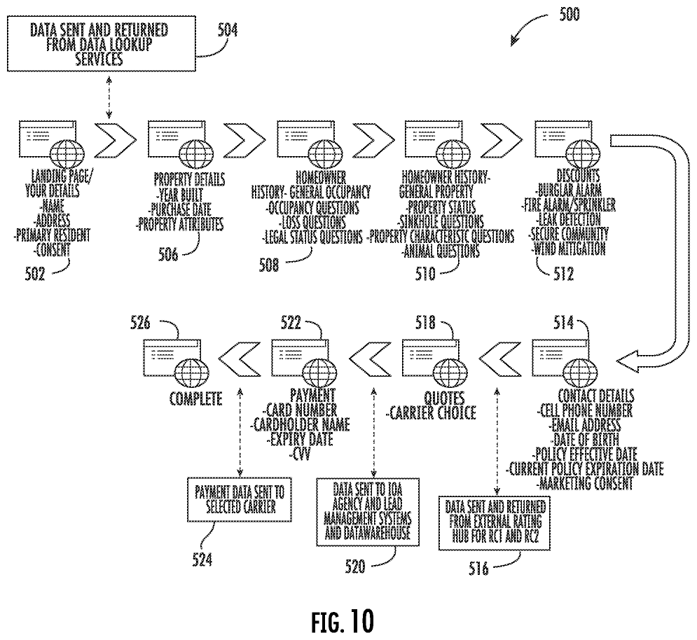

Referring now to FIG. 10, a flow diagram of a method of generating a bindable home insurance quote 500 is shown. The method 500 begins, at 502, where basic customer data is entered including name, address, consent, and policy effective date, for example. The customer data is sent, at 504, and property data is returned from data lookup services. The property data is presented to the customer, at 506, and the customer can add or edit the home data. This includes home purchase date, year built, and property attributes, for example. The property data is sent, at 508, and property data is returned from data lookup services. The property data is presented to the customer, at 510, and the customer can add or edit the property data. This may include questions regarding property status, sinkhole information, property characteristics, and pet or animals on the property, for example. Moving to 512, the customer can answer questions about the property that may qualify them for discounts.

The customer then enters their contact details, at 514, which may include a cell phone number, email address, date of birth, and marketing consent, for example. Data is sent, at 516, and returned from an external rating engine for rate call 1 and rate call 2 via the handshaking algorithm.

The customer, at 518, is presented with bindable insurance quotes that can be purchased directly. The customer is presented with details regarding the coverage levels of the proposed insurance policy, and allowing the customer to add or edit coverage levels. The customer can also view comparative quotes from multiple insurance carriers as availability allows. The pertinent data may be sent to lead management systems and stored, at 520, before or after the customer selects the policy.

The customer then enters payment information, at 522, to finalize the purchasing and binding of the selected insurance policy. The payment information includes credit card number, cardholder name, and expiration date, for example, and is provided to the carrier, at 524. Moving to 526, confirmation is provided to the customer that their new insurance policy has been purchased and a policy number provided by the carrier to the customer, and the process is complete.

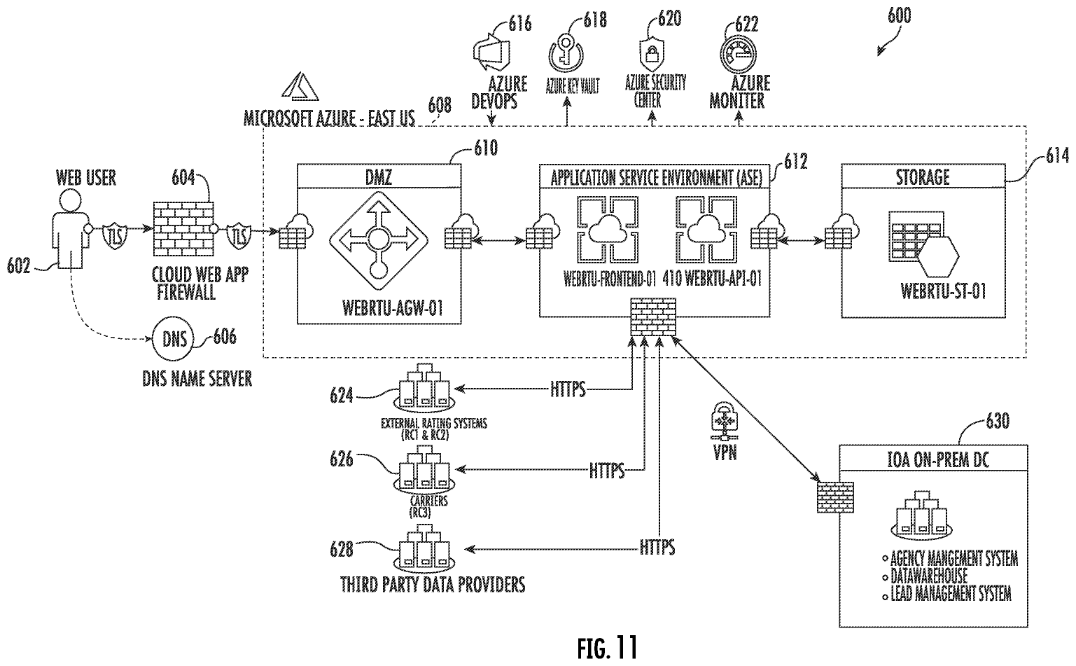

Referring now to FIG. 11, a general block diagram of high level architecture of the system of FIG. 1 is shown and generally designated 600. A customer or user 602 uses a web application 604 provided by a domain name server 606 to access the enterprise server bus 608. The enterprise server bus 608 implements a communication system between mutually interacting software applications in a service-oriented architecture.

The enterprise server bus 608 includes several additional features. For example, the enterprise server bus 608 includes a server 616 to provide version control, reporting, requirements management, project management, automated builds, testing and release management capabilities. The enterprise server bus 608 also includes a vault 618 to store keys, passwords, and certificates, for example. In addition, the enterprise server bus 608 includes a security center 620 that comprises a unified infrastructure security management system that strengthens the security posture of the system. The enterprise server bus 608 includes a monitor 622 that is configured to maximize the availability and performance of the applications and services by delivering a comprehensive solution for collecting, analyzing, and acting on telemetry from cloud and on-premises environments.

The web application. 604 is configured to communicate with a DMZ Network 610 as a subnetwork. and acts as the exposed point to untrusted networks such as the Internet. In turn, the DMZ 610 is in communication with an application service environment (ASE) 612 for an application frontend API and an application backend API

The ASE 612 is in communication with. application data storage 614 in addition to the external rating systems 624 used for the rate calls. The external rating systems 624 are configured to send customer and enrichment information in exchange for a bindable (quote for insurance as explained above. The ASE 612 is also in communication with the insurance carriers 626 via an API that is configured to communicate payment data and complete the insurance binding process with the carrier.

Third party data providers 628 are also in communication with the ASE. 612 in order to retrieve customer or property data to prefill and default policy information. The ASE 612 may also be configured to communicate with agency resources Eau that may include an agency management system, a data warehouse, and a lead management system, for example. The agency mar age system is used by an agency to manage customers and insurance policies and the data warehouse is used to store data for purposes of data reporting and mining. The lead management system is configured to store data for potential customers in order to follow up and sell insurance.

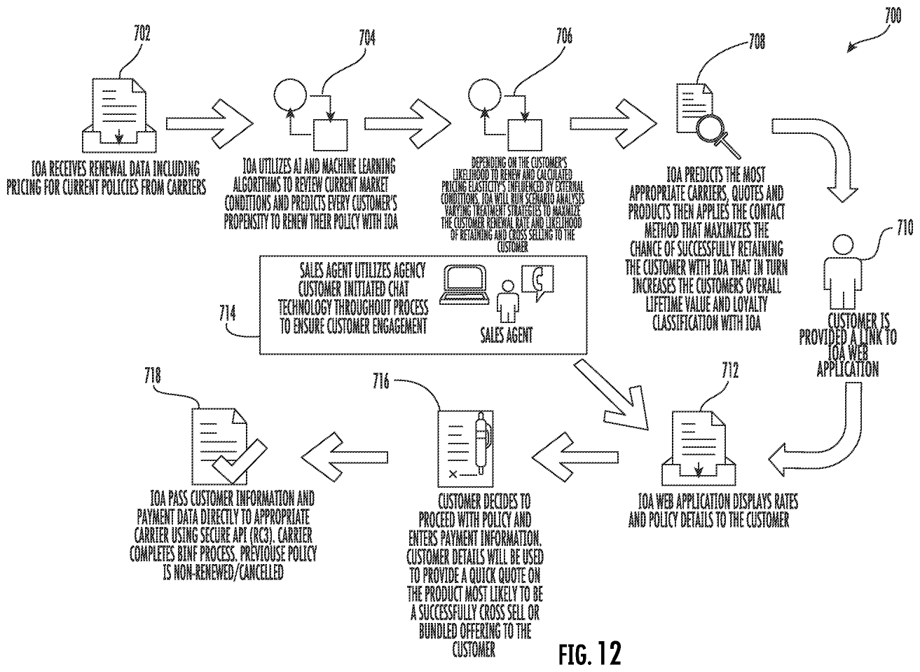

Referring now to FIG. 12, a flow diagram of a method for renewing an insurance policy using the system of FIG. 1 is depicted and designated 700. The method 700 includes an agency receiving renewal data including pricing for current policies from carriers, at 702, and reviewing current market conditions, at 704, to predict a likelihood that the customer will renew its insurance policy. Depending on the likelihood that the customer will renew and calculated elasticity influenced by external factors, the method 700 includes running scenario analysis by varying treatment strategies to maximize the customer renewal rate and likelihood of retaining and cross selling the customer, at 706.

Moving to 708, the method 700 includes predicting the appropriate insurance carriers, quotes and products then applying the contact method that maximized the chance of successfully retaining the customer and in turn increasing the customer overall lifetime value and loyalty classification. The method 700 includes transmitting and providing a link to the customer, at 710, of an insurance renewal application. The method 700 also includes displaying relevant carriers and policy details to the customer, at 712. The method 700 includes receiving a response that the customer, at 716, has decided to renew the policy and enters payment information. In addition, the method 700 includes, at 716, providing a quote on an additional product, that has a high likelihood to be a successful cross sell or bundled offering to the customer.

The method 700 includes, at 718, that the customer details and payment information is transmitted to the selected insurance carrier using secure API (i.e., rate call 3), and the insurance carrier completes the binding process. In addition, the method 700 includes, at 714, contacting the customer throughout the insurance renewal process using chat technology or other similar technology that those in the art can appreciate to ensure engagement. In particular, the method 700 includes contacting the customer once the quote is provided to the customer to ensure any questions are answered and providing assistance through the renewal process.

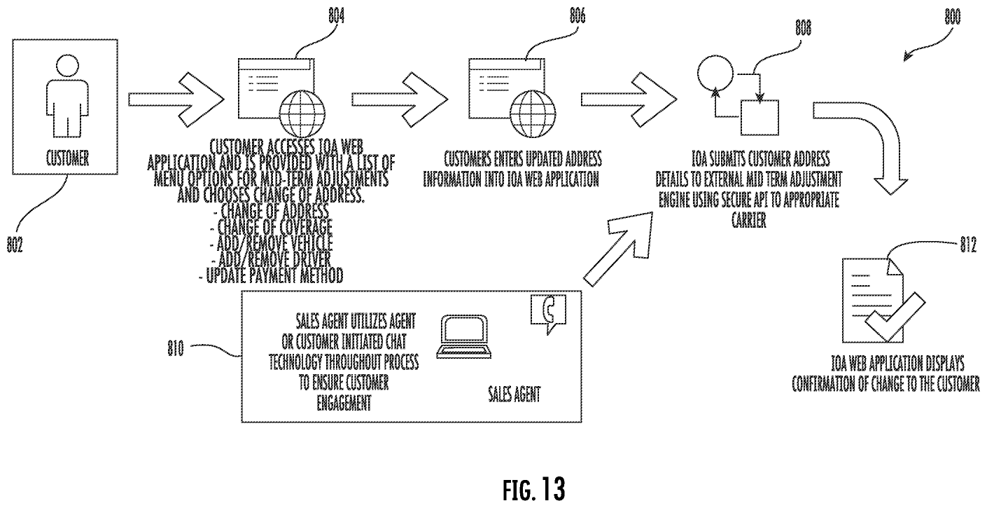

FIG. 13 depicts a flow diagram of a method 800 of making a mid-term change of address to the policy using the system of FIG. 1. The method 800 begins, at 802, with accessing by the customer, at 804, a front end application that displays a plurality of menu options for mid-term adjustments. This may include change of address, change of coverage, add or remove vehicle, add or remove a driver, and update payment information, for example. Moving to 806, the method 800 includes entering by the customer updated. address information when the customer selects the change, of address from the menu, and transmitting, at 808, the updated address information to an external mid-term adjustment engine using a secure API to the appropriate carrier. In addition, the method 800 includes, at 812, displaying a confirmation that the change of address was accepted. The method 800 also includes, at 810, contacting: the customer throughout the change of address process using chat technology, co-browsing, email, customer or agent initiated and text, or other similar technology that those in the art can. appreciate to ensure engagement.

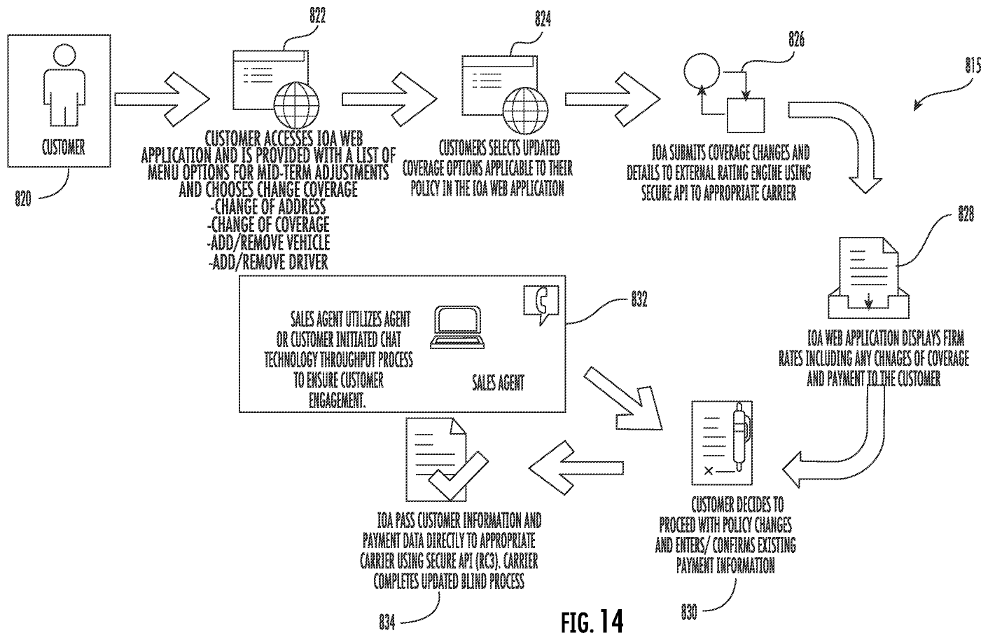

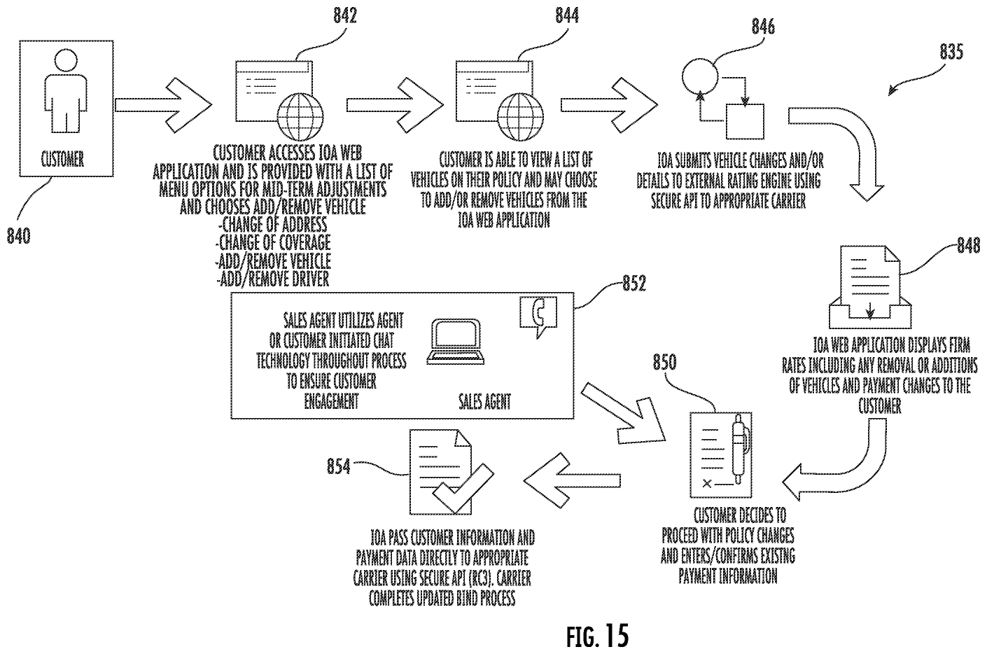

Referring now to FIG. 14, is a flow diagram of a method 815 of making a mid-term change of coverage to the insurance policy using the system of FIG. 1. The method 815 begins, at 820, with accessing by the customer, at 822, a front end application that displays a plurality of menu options for mid-term adjustments similar to that described above with respect to the method 800 to update address information,

Moving to 824, the method 815 includes entering by the customer coverage changes when the customer selects the change coverage option from the menu, and transmitting, at 826, the coverage changes to an external mid-term adjustment engine using a secure API to the appropriate carrier. In addition, the method 815 includes, at 828, displaying policy rate changes due to the coverage change and entering payment information, at 830. Moving to 834, the coverage changes and payment information is transmitted to the selected insurance carrier using secure API (i.e., rate call), and the insurance carrier completes the binding process for the coverage change. The method 815 also includes, at 832, contacting the customer throughout the coverage change process using chat technology, co-browsing, email, customer or agent initiated and text, or other similar technology that those in the art can appreciate to ensure engagement.

FIG. 15 depicts a flow diagram of a method 835 of making a mid-term addition or removal of a vehicle from the insurance policy using the system of FIG. 1. The method 835 begins, at 840, with accessing by the customer, at 842, a front end application that displays a plurality of menu options for mid-term adjustments similar to that described above and includes an option to add or remove a vehicle.

Moving to 844, the method 835 includes displaying a list of vehicles on a current insurance policy, and the customer chooses to add or remove a vehicle, and transmitting, at 846, the vehicle changes to an external mid-term adjustment engine using a secure. API to the appropriate carrier. In addition, the method 835 includes, at 818, displaying policy rate changes due to the vehicle changes and entering payment information, at 850. Moving to 854, the vehicle changes and payment information is transmitted to the selected insurance carrier using secure API (i.e., rate call 3), and the insurance carrier completes the binding process for the vehicle changes. The method 835 also includes, at 852, contacting the customer throughout the coverage change process using chat technology or other similar technology that those in the art can appreciate to ensure engagement with the customer.

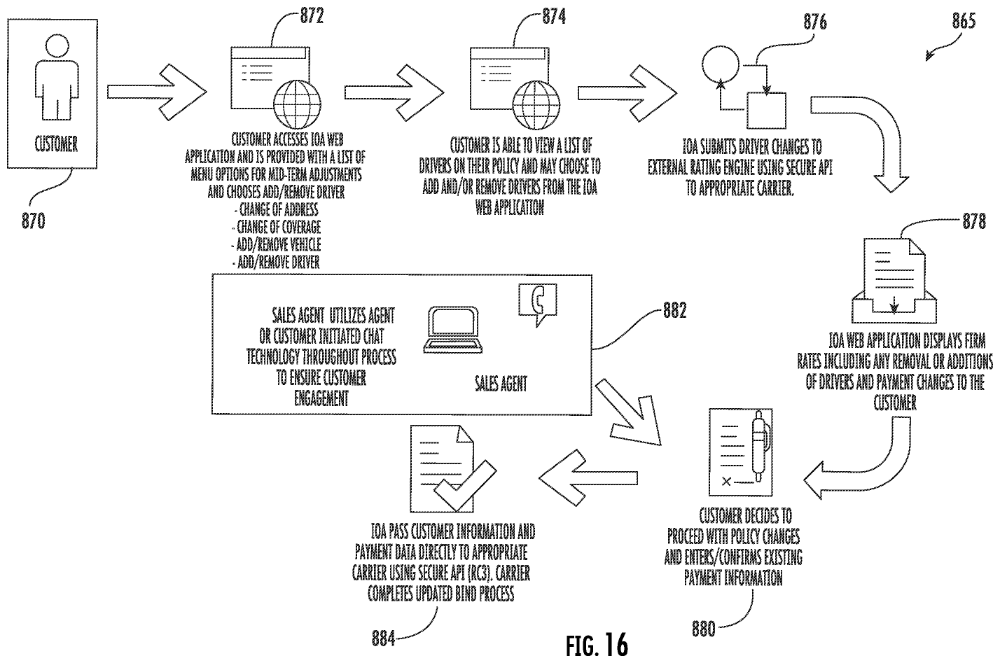

Referring now to FIG. 16, a flow diagram of a method of making a mid-term addition or removal of a driver from the insurance policy using the system of FIG. 1 is depicted. The method 865 begins, at 870, with the customer, at 872, accessing the front end application to add or remove a driver similar to that described above for the method 835 for vehicle changes.

The method 865 includes, at 874, displaying a list of drivers on a current insurance policy, and the customer chooses to add or remove a driver, and transmitting, at 676, the driver changes to an external mid-term adjustment engine using a secure API to the appropriate carrier. In addition, the method 865 includes, at 878, displaying policy rate changes due to the driver changes and entering payment information, at 880. Moving to 884, the driver changes and payment information is transmitted. to the selected insurance carrier using secure API (i.e., rate call 3), and the insurance carrier completes the binding process for the driver changes. The method 865 also includes, at 882, contacting the customer throughout the coverage change process using chat technology or other similar technology that those in the art can appreciate to ensure engagement with the customer.

Another aspect is directed to a non-transitory computer readable, medium for generating a bindable automobile insurance quote using an enterprise service bus configured to manage communications between mutually interacting software applications, and with the non transitory computer readable medium having a plurality of computer executable instructions for causing the enterprise service bus to perform steps. The computer executable instructions include receiving customer data entered by a customer using a graphical user interface (GUI) at a model view controller (MVC) that is in communication with an application programming interface (API), transmitting the customer data by the API to a data enrichment module, where vehicle or property data is returned from the data enrichment module and presented to the customer who can verify, add or edit the vehicle or property data using the GUI, and transmitting the verified vehicle or property data to the data enrichment module, where driver or property data is returned from the data enrichment module and presented to the customer who can verify, add or edit the driver or property data using the GUI.

In addition, the computer executable instructions may include receiving customer contact details entered by the customer using the GUI, retrieving motor vehicle data (MVR) data from a data source to identify any specific violations or incidents and is used to rate drivers for carrier qualification and pricing for auto insurance, and transmitting customer data and vehicle or property data to an external rating engine via a handshaking algorithm, to obtain at least one rate call from insurance carriers for at least one bindable quote for an insurance policy. The computer executable instructions may also include displaying the at least one bindable quote for the insurance policy to the customer using the GUI, receiving a selection from the customer using the GUI of a selected insurance policy from the at least one bindable quote to purchase, transmitting the selected insurance policy to a lead management system and stored, receiving payment information from the customer using the GUI Lo finalize the purchasing and binding of the selected insurance policy, and transmitting a confirmation to the customer of their new insurance policy once payment is processed.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A system to generate a bindable insurance quote from insurance carriers, the system comprising:
an enterprise service bus configured to manage communications between mutually interacting software applications of the system;
an application programming interface (API) in communication with the enterprise service bus;
a model view controller (MVC) in communication with the API;
a data enrichment module in communication with the API, the data enrichment module comprising third party web services used to retrieve customer and property data to pre fill an insurance application with policy information;
an underwriting module in communication with the enterprise service bus, the underwriting module comprises a service application configured to communicate customer and property data between a plurality of insurance carriers; and
an external rating engine and a handshaking algorithm, the handshaking algorithm interposed between the external rating engine and the underwriting module and configured to manage rate calls with the external rating engine for the bindable insurance quote.

2. The system of claim 1, further comprising a plurality of insurance frontend graphical user interfaces (GUIs) are embedded into respective partner HTML pages as an inline frame element.

3. The system of claim 1, further comprising a plurality of partner branded insurance frontend graphical user interfaces (GUIs) configured to enter the customer and property data.

4. The system of claim 1, further comprising a widget embedded into a respective partner HTML page and configured to launch an inline frame element on the respective partner HTML page or to open a respective partner branded insurance frontend graphical user interface (GUI) when the widget is toggled in order to enter the customer and property data.

5. The system of claim 1, further comprising a plurality of partner insurance frontend graphical user interfaces (GUIs) configured to collect the customer and property data and transmit the customer and property data to the enterprise server bus via a partner API in order to receive the bindable insurance quote.

6. The system of claim 1, wherein the external rating engine comprises web services configured to communicate to the plurality of insurance carriers to send customer and enrichment information in exchange for the bindable insurance quote.

7. The system of claim 6, further comprising a marketing module in communication with the service bus and a customer relationship (CRM) module, wherein the CRM module comprises a system configured to manage new leads.

8. The system of claim 7, further comprising a portfolio management module in communication with the service bus, wherein the portfolio management module. comprises a service application configured to communicate policy and customer information to agency management services (AMS).

9. The system of claim 8, wherein the AMS comprises a management system configured to manage customers and their respective insurance policies.

10. The system of claim 9, further comprising a payment API in communication with insurance carrier direct services, the MVC, and the enterprise service bus, wherein the insurance direct services comprise web services and third party applications for insurance carrier payment processing.

11. A method to generate a bindable insurance quote, from insurance carriers using an enterprise service bus configured to manage communications between mutually interacting software applications, the method comprising:
receiving customer and property data that was entered using a graphical user interface (GUI) of a model view controller (MVC) that is in communication with an application programming interface (API);
transmitting the customer and property data by the API to a data enrichment module comprising third party web services used to retrieve additional customer and property data to prefill an insurance application with policy information, wherein enriched customer and property data is returned from the data enrichment module;
transmitting the enriched customer and property data to an underwriting module, the underwriting module comprises a service application configured to communicate the enriched customer and property data between a plurality of insurance carriers; and
transmitting the enriched customer data from the underwriting module to an external rating engine via a handshaking algorithm, the handshaking algorithm interposed between the external rating engine and the underwriting module and configured to manage rate calls with the external rating engine for the bindable insurance quote.

12. The method of claim 11, further comprising embedding a plurality of insurance frontend graphical user interfaces (GUIs) into a respective partner HTML page as an inline frame element in order to enter the customer and property data, and each or the plurality of insurance frontend GUIs are in communication with the MVC.

13. The method of claim 11, further comprising providing a plurality of partner branded insurance frontend graphical user interfaces (GUIs) configured to enter the customer and property data.

14. The method of claim 11, further comprising embedding a widget into a respective partner HTML page and launching an inline frame element on the respective partner HTML page or opening a respective partner branded insurance frontend GUI when the widget is toggled in order to enter the customer and property data.

15. The method of claim 11, further comprising collecting the customer and property data using a plurality of partner insurance frontend graphical user interfaces (GUIs); and
transmitting the customer and property data to the enterprise server bus via a partner API to receive the bindable insurance quote from the plurality of insurance carriers.

16. The method of claim 11, further comprising:
displaying the bindable insurance quote for the insurance policy using the GUI;
receiving a selection using the GUI of a selected insurance policy from the bindable insurance quote to purchase;
transmitting the selected insurance policy to a lead management system and stored;
receiving payment information from the customer to finalize the purchasing and binding of the selected insurance policy; and
transmitting a confirmation to the customer of their new insurance policy once payment is processed.

17. A non-transitory computer readable medium operable on one or more processors for interfacing between an enterprise service bus, an application programming interface (API), a model, view controller (MVC), a date enrichment module, an underwriting module, and an external rating engine to generate a bindable insurance quote, and with the non-transitory computer readable medium having a plurality of computer executable instructions for causing the enterprise service bus to perform steps comprising:
receiving enriched customer data from the API in communication with the data enrichment module, the data enrichment module comprising third party web services used to retrieve customer and property data to prefill an insurance application with policy information; and
transmitting the enriched customer data to the underwriting module that comprises a service application. configured to communicate the customer and property data be a plurality of insurance carriers, and the underwriting module is configured to transmit the enriched customer data to an external rating engine via a handshaking algorithm to obtain at least one rate call from insurance carriers for the bindable insurance quote for an insurance policy.

18. The non-transitory computer readable, medium according to claim 17, wherein a plurality of insurance frontend graphical user interfaces (GUIs are embedded into a respective partner HTML page as an inline frame element and configured to enter the customer and property data.

19. The non-transitory computer readable medium according to claim 17, wherein a plurality of partner branded insurance frontend graphical user interfaces (GUIs) are configured to enter the customer and property data.

20. The non-transitory computer readable medium according to claim 17, wherein a widget embedded into a respective partner HTML page to launch an inline frame element on the respective partner HTML pa e or to open a respective, partner branded insurance frontend GUI when the widget is toggled.

21. The non-transitory computer readable medium according to claim 17, further comprising computer executable instructions for collecting the customer and property data using a plurality of partner insurance frontend graphical user interfaces (GUIs); and
transmitting the customer and property data to the enterprise server bus via a partner API in order to receive the bindable, insurance quote from the plurality of insurance carriers.

22. The non-trans computer readable medium according to claim 17 further comprising computer executable instructions for:
displaying the bindable insurance quote for the insurance policy using the GUI;
receiving a selection using the GUI to purchase the insurance policy when the bindable insurance quote is accepted;
transmitting the insurance policy to a lead management system and stored; receiving payment information from the customer to finalize the purchasing and binding of the insurance policy; and
transmitting a confirmation to the customer that the purchase of the insurance policy is complete.
